(19) United States
(12) Patent Application Publication
(10) Pub. No.: US 2020/0201204 A1
(43) Pub. Date: Jun. 25, 2020

(54) DEVELOPING DEVICE AND IMAGE FORMING APPARATUS PROVIDED WITH SHUTTER

(71) Applicant: TOSHIBA TEC KABUSHIKI KAISHA, Tokyo (JP)

(72) Inventor: Masayuki KASUKAWA, Misato Saitama (JP)

(73) Assignee: TOSHIBA TEC KABUSHIKI KAISHA, Tokyo (JP)

(21) Appl. No.: 16/231,156

(22) Filed: Dec. 21, 2018

(51) Int. Cl. G03G 15/08; G03G 21/16

(52) U.S. Cl. CPC G03G 15/0886; G03G 15/0875; G03G 2215/0692; G03G 2215/085; G03G 21/1676

(57) ABSTRACT

A developing device includes a developing roller, a casing, a dividing wall, and a shutter. A first chamber and a second chamber are formed in the casing. An opening is formed in the casing. The opening permits the first chamber to communicate with the outside and faces the developing roller. The dividing wall is disposed in the casing. The dividing wall divides the first chamber and the second chamber. At least one communicating window is formed on the dividing wall. The communicating window connects the first chamber and the second chamber. The shutter is selectively switched between a first state in which the communicating window is opened and a second state in which the communicating window is blocked.

### FIELD

Embodiments described herein relate generally to a developing device and an image forming apparatus.

### BACKGROUND

An image forming apparatus has a developing device for accommodating a developer composed of a carrier and a toner. The developing device supplies the developer to a surface of a photoconductive drum. The developing device includes a casing for accommodating the developer and a developing roller facing an opening of the casing. The image forming apparatus develops an electrostatic latent image formed on the drum surface by supplying the developer through the developing roller to the surface of the photoconductive drum. The image forming apparatus may be shipped with the developer filled in the developing device in order to reduce a work load such as an initial setting after shipment or the like. In this case, in completion of the initial setting of the image forming apparatus, the developer in the casing is isolated from the opening to prevent the developer from leaking out through the opening of the casing. For example, as a method of isolating the developer, there is provided a method to stop the movement of the developer inside the casing by attaching a sheet material in a removable manner in the casing.

### DESCRIPTION OF THE DRAWINGS

FIG. 1 is a schematic diagram illustrating an example of an overall configuration of an image forming apparatus according to a first embodiment;

FIG. 2 is a block diagram schematically illustrating functional blocks of the image forming apparatus according to the first embodiment;

FIG. 3 is a cross-sectional view of a developing device when viewed from the front side according to the first embodiment;

FIG. 4 is a cross-sectional view showing a portion corresponding to an IV-IV line in FIG. 3;

FIG. 5 is a top view schematically illustrating a cross-sectional structure around a partition wall according to the first embodiment;

FIG. 6 is a side view schematically illustrating a structure around the partition wall according to the first embodiment;

FIG. 7 is a side view schematically illustrating a structure around the partition wall according to the first embodiment;

FIG. 8 is a cross-sectional view of the developing device when viewed from the front side according to the first embodiment;

FIG. 9 is a cross-sectional view of a developing device when viewed from the front side according to a second embodiment;

FIG. 10 is a top view schematically illustrating a structure around a dividing wall according to the second embodiment; and

FIG. 11 is a cross-sectional view of a developing device when viewed from the front side according to a third embodiment.

### DETAILED DESCRIPTION

In the above-described apparatuses, when the sheet material is attached in the casing, foreign matter such as adhesive components and debris of the sheet material may remain in the casing after the sheet material is removed. If the foreign matter remains in the casing, the foreign matter flows together with the developer, resulting in failure in image formation.

In some embodiments, a developing device comprises a developing roller, a casing, a dividing wall, and a shutter. The developing roller supplies a developer containing a toner to a surface of a photoconductor. The developing roller develops an electrostatic latent image. The casing accommodates the developer. A first chamber and a second chamber are formed in the casing. An opening is formed in the casing. The opening enables the first chamber to communicate with the outside (exterior) and faces the developing roller. The dividing wall is disposed in the casing. The dividing wall divides the first chamber and the second chamber. At least one communicating window is formed on the dividing wall. The communicating window connects the first chamber and the second chamber. The shutter are selectively switched between a first state in which the communicating window is opened and a second state in which the communicating window is blocked.

Hereinafter, an image forming apparatus according to some embodiments is described with reference to the accompanying drawings. In each drawing, the same components are denoted with the same reference numerals.

### First Embodiment

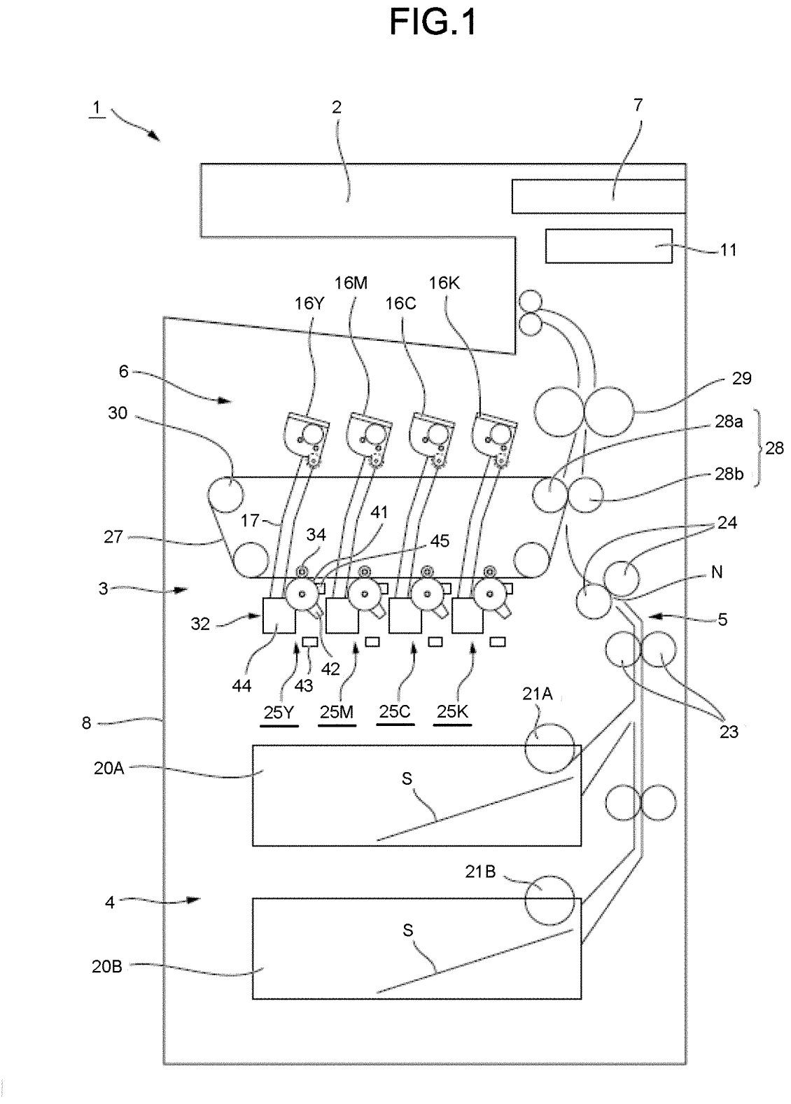

FIG. 1 is a schematic diagram illustrating an example of an overall configuration of an image forming apparatus according to the first embodiment.

As shown in FIG. 1, for example, the image forming apparatus 1 is an MFP (Multi-Function Peripheral). The image forming apparatus 1 reads out an image formed on a sheet-like image receiving medium (hereinafter, referred to as a “sheet”) such as a paper to generate digital data (image file). The image forming apparatus 1 forms an image on a sheet using a toner based on the digital data. The image forming apparatus 1 includes a scanner section 2, a printer section 3, a sheet housing section 4, a conveyance section 5, a toner replenishment section 6, a display section 7, and a controller 11. Below, in the following description, the image forming apparatus 1 is in a state of being placed on a horizontal plane. A side of the image forming apparatus 1 shown in FIG. 1 is defined as a front side, and an opposite side thereof is defined as a back side.

The scanner section 2 reads out image information of an object to be copied as intensity of light. The scanner section 2 outputs the read image information to the controller 11.

Based on image information from the scanner section 2 or an external device, the printer section 3 forms an output image (hereinafter, referred to as a “toner image”) with a developer including a toner and a carrier. The printer section 3 transfers the toner image onto the surface of a sheet S. The printer section 3 applies heat and pressure to the toner image on the surface of the sheet S to fix the toner image on the sheet S.

The sheet housing section 4 supplies the sheets S one by one to the printer section 3. The sheet housing section 4 has a plurality of sheet feed cassettes 20A and 20B. Each of the sheet feed cassettes 20A and 20B accommodates sheets S of preset size and type. The sheet feed cassettes 20A and 20B have pickup rollers 21A and 21B, respectively. The pickup rollers 21A and 21B pick up the sheets S one by one from the sheet feed cassettes 20A and 20B, respectively. The pickup rollers 21A and 21B supply the sheets S taken out to the conveyance section 5.

The conveyance section 5 has conveyance rollers 23 and registration rollers 24. The conveyance section 5 conveys the sheet S supplied from the pickup rollers 21A and 21B to the registration rollers 24. The registration rollers 24 convey the sheet S in accordance with a timing at which the printer section 3 transfers the toner image onto the sheet S. A tip in a conveyance direction of the sheet S conveyed by the conveyance rollers 23 abuts against a nip N of the registration rollers 24. The conveyance roller 23 adjusts the position of the tip of the sheet S in the conveyance direction by bending the sheet S. The registration roller 24 aligns the tip of the sheet S fed from the conveyance roller 23 at the nip N. Furthermore, the registration roller 24 conveys the sheet S towards a transfer section 28 described later.

In the toner replenishment section 6, toner cartridges 16Y, 16M, 16C and 16K for accommodating the toner are mounted. The toner cartridges 16Y, 16M, 16C and 16K accommodates yellow toner, magenta toner, cyan toner, and black toner, respectively. In the toner replenishment section 6, a replenishment tube 17 is provided. The toner discharged from the toner cartridges 16Y, 16M, 16C and 16K circulates through the replenishment tube 17.

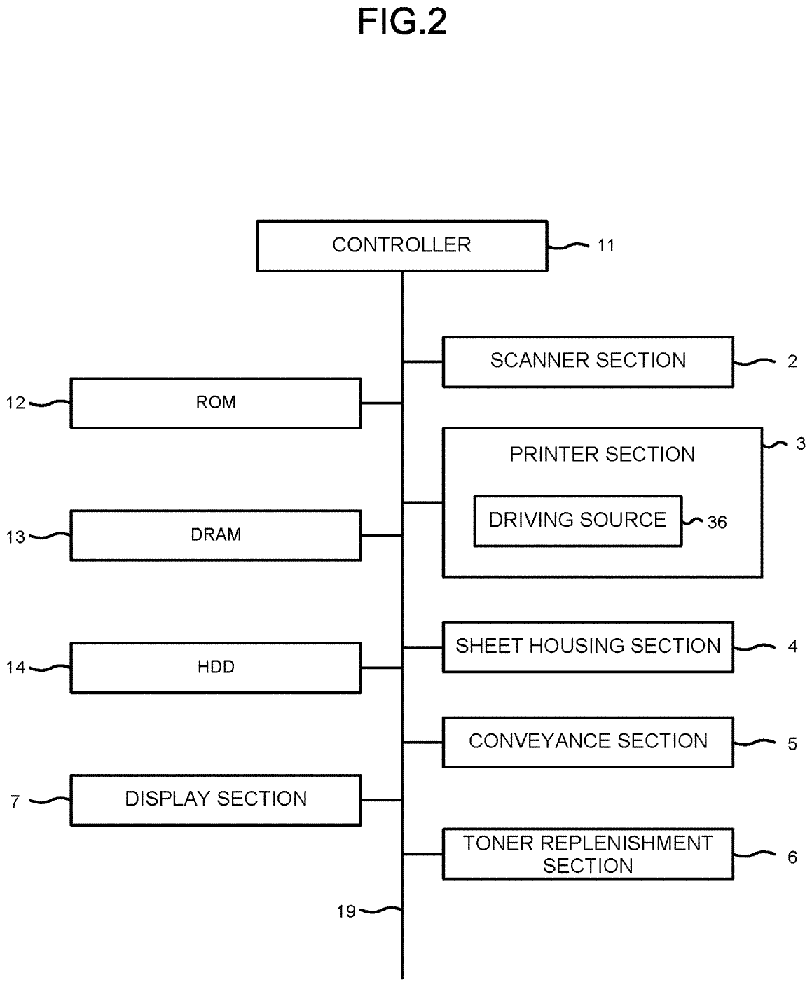

FIG. 2 is a block diagram schematically illustrating the functional blocks of the image forming apparatus according to the first embodiment.

As shown in FIG. 2, the image forming apparatus 1 further includes a ROM (Read Only Memory) 12, a DRAM (Dynamic Random Access Memory) 13, and a HDD (Hard Disk Drive) 14. Each functional section is connected to enable data communication via a system bus 19. The scanner section 2, the printer section 3, the sheet housing section 4, the conveyance section 5 and the toner replenishment section 6 include devices such as sensors or driving sources (motors) controlled by the controller 11.

The controller 11 controls each device connected via the system bus 19. The ROM 12 stores various control programs required by the controller 11 to operate. The DRAM 13 is used as a temporary storage area of data when the controller 11 executes a program. The HDD 14 stores control data. The HDD 14 stores, for example, various messages displayed on the display section 7. The HDD 14 stores, for example, data obtained by executing the program by the controller 11.

The printer section 3 is described in detail below.

As shown in FIG. 1, the printer section 3 has image forming sections 25Y, 25M, 25C, and 25K, an intermediate transfer belt 27, the transfer section 28, and a fixing device 29.

The intermediate transfer belt 27 is an endless belt. Tension is applied to the intermediate transfer belt 27 by a plurality of rollers abutting against an inner peripheral surface of the intermediate transfer belt 27. The intermediate transfer belt 27 is stretched in a flat manner. The inner peripheral surface of the intermediate transfer belt 27 abuts against a support roller 28a and a transfer belt roller 30 at most distant positions in a stretching direction.

The support roller 28a is a part of the transfer section 28. The support roller 28a guides the intermediate transfer belt 27 to a secondary transfer position.

Below the intermediate transfer belt 27, the image forming sections 25Y, 25M, 25C and 25K are arranged in this order from the transfer belt roller 30 towards the transfer section 28. The image forming sections 25Y, 25M, 25C and 25K are arranged at intervals in a region between the transfer belt roller 30 and the support roller 28a. The image forming section 25Y forms a yellow toner image to be transferred onto the sheet S on the intermediate transfer belt 27. The image forming section 25M forms a magenta toner image to be transferred onto the sheet S on the intermediate transfer belt 27. The image forming section 25C forms a cyan toner image to be transferred onto the sheet S on the intermediate transfer belt 27. The image forming section 25K forms a black toner image to be transferred onto the sheet S on the intermediate transfer belt 27. The image forming sections 25Y, 25M, 25C and 25K are configured in the same manner. In the following description of the structure of the image forming sections 25Y, 25M, 25C and 25K, the image forming section 25Y is described as an example.

The image forming section 25Y has an image forming unit 32 and a primary transfer roller 34.

The image forming unit 32 has a photoconductive drum 41 (photoconductor), a charger 42, an exposure section 43, a developing device 44, and a cleaning unit 45.

The photoconductive drum 41 is arranged below the intermediate transfer belt 27. The photoconductive drum 41 faces the lower surface of the intermediate transfer belt 27.

In the vicinity of the photoconductive drum 41, the charger 42, the exposure section 43, the developing device 44, the primary transfer roller 34, and the cleaning unit 45 are arranged clockwise as viewed from the front side.

The charger 42 charges the photoconductive drum 41. The charger 42 has, for example, a charging electrode composed of a discharge wire or a needle-shaped electrode.

The exposure section 43 irradiates the surface of the charged photoconductive drum 41 with LED light controlled to emit light based on the image information. The exposure section 43 may be configured to emit laser light from a laser light source. The exposure section 43 of the image forming section 25Y is supplied with the image information for yellow. In the photoconductive drum 41, the exposure section 43 emits the LED light based on the image information after charging. The exposure section 43 forms an electrostatic latent image based on the image information for yellow on the surface of the photoconductive drum 41.

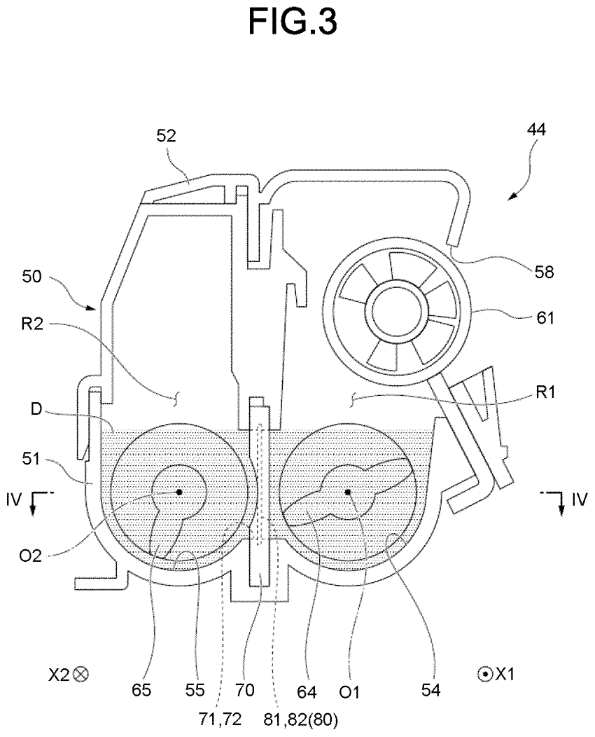

The developing device 44 accommodates a developer D (refer to FIG. 3). The developing device 44 charges the toner contained in the developer D accommodated therein. Specifically, the toner is frictionally charged when the developer D is stirred. The toner adheres to the surface of the carrier. The toner is supplied from the toner cartridge 16Y to the developing device 44. The developing device 44 supplies the charged toner to the surface of the photoconductive drum 41 opposite to the developing device 44. The toner adheres to the surface of the photoconductive drum 41 in accordance with the electrostatic latent image. The developing device 44 develops the electrostatic latent image formed by the exposure section 43.

The cleaning unit 45 removes the toner that is not transferred and remains on the surface of the photoconductive drum 41 after the primary transfer by scraping off the toner, for example.

The primary transfer roller 34 is a conductive roller. The primary transfer roller 34 is pressed to contact with the photoconductive drum 41 via the intermediate transfer belt 27. A transfer bias voltage is applied to the primary transfer roller 34. As a result, the toner image is primarily transferred onto the intermediate transfer belt 27.

The developing device 44 is described below in detail.

FIG. 3 is a cross-sectional view of the developing device when viewed from the front side according to the first embodiment. FIG. 3 shows a state in which an initial setting of the image forming apparatus 1 is completed and the image forming apparatus 1 can be used (the details are described later).

As shown in FIG. 3, the developing device 44 has a casing 50, a developing roller 61, a first mixer 64, a second mixer 65, a partition wall 70 (dividing wall), and a shutter device 80.

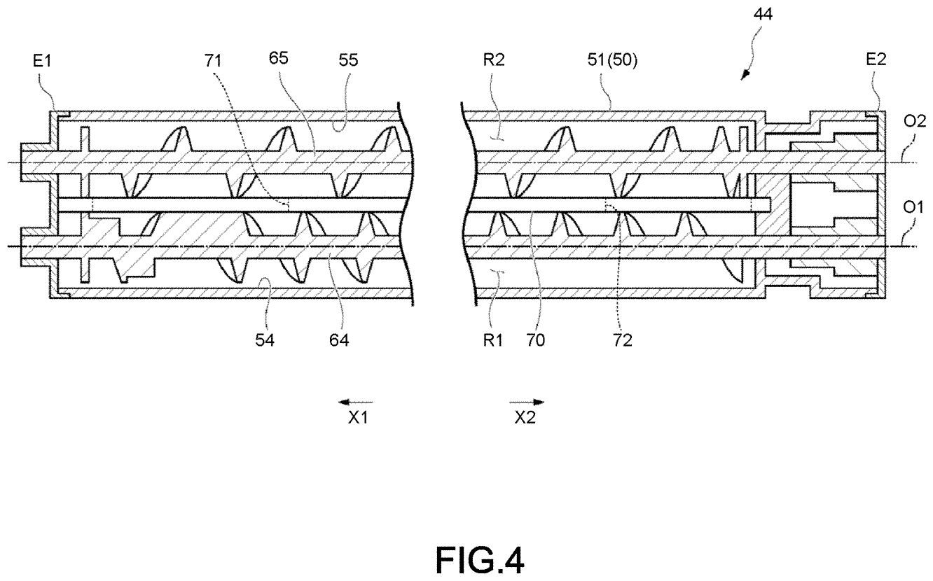

FIG. 4 is a cross-sectional view showing a portion corresponding to an IV-IV line in FIG. 3.

As shown in FIG. 3 and FIG. 4, the casing 50 is a container for accommodating the developer D. The casing 50 extends from a first end E1 of the developing device 44 to a second end E2 thereof. The first end E1 of the developing device 44 is an end facing the front side. The second end E2 of the developing device 44 is an end facing the back side. In other words, the casing 50 extends in a front and back direction as a longitudinal direction thereof. Here, a first direction X1 and a second direction X2 are defined. The first direction X1 is parallel to the longitudinal direction of the casing 50 and is a direction from the second end E2 of the developing device 44 to the first end E1 thereof. The second direction X2 is opposite to the first direction X1. In the casing 50, a first chamber R1 and a second chamber R2 are formed (the details thereof are described later). The casing 50 includes a developer housing section 51 and a cover 52.

In the developer housing section 51, a first groove 54 and a second groove 55 opening upwards are formed. The first groove 54 and the second groove 55 each extend along the longitudinal direction of the casing 50 from the first end E1 of the developing device 44 to the second end E2 thereof. The first groove 54 and the second groove 55 are arranged in parallel in a horizontal direction orthogonal to the longitudinal direction of the casing 50.

The cover 52 is disposed above the first groove 54 and the second groove 55. The cover 52 is disposed to block the first groove 54 and the second groove 55 from the above. An opening 58 is formed between the developer housing section 51 and the cover 52. The opening 58 enables the inside of the casing 50 to communicate with the outside thereof, i.e., the external environment that is exterior to the casing. The opening 58 is formed at a position facing the photoconductive drum 41 (refer to FIG. 1). On the cover 52, a developer replenishment port (not shown) is formed. The replenishment tube 17 of the toner replenishment section 6 (refer to FIG. 1 for both) is connected to the developer replenishment port. When a concentration of the toner in the developer D falls below a predetermined concentration, the toner is replenished from the toner cartridge 16Y through the developer replenishment port.

The developing roller 61 is arranged above the first groove 54. The developing roller 61 is rotatably supported by the casing 50. The developing roller 61 faces the opening 58 of the casing 50. A part of the developing roller 61 is exposed to the outside from the opening 58 of the casing 50. The surface of the developing roller 61 is close to the surface of the photoconductive drum 41. The developing roller 61 supplies the developer D to the surface of the photoconductive drum 41. Furthermore, the developing roller 61 develops the electrostatic latent image on the surface of the photoconductive drum 41. The developing roller 61 is rotated by a driving source 36 (refer to FIG. 2). The driving source 36 is connected to the system bus 19 and is controlled by the controller 11 (refer to FIG. 2).

As shown in FIG. 4, the first mixer 64 is arranged in the first groove 54 of the developer housing section 51. The first mixer 64 rotates about a first axis O1. The first axis O1 extends along the longitudinal direction of the developer housing section 51. Both ends of the first mixer 64 are rotatably supported by the developer housing section 51, respectively. The first mixer 64 has a spiral stirring blade on a surface thereof. The stirring blade extends over almost the entire length of the first groove 54.

The second mixer 65 is arranged in the second groove 55 of the developer housing section 51. The second mixer 65 rotates around a second axis O2. The second axis O2 extends parallel to the first axis O1. Both ends of the second mixer 65 are rotatably supported by the developer housing section 51, respectively. The second mixer 65 has a spiral stirring blade on a surface thereof. The stirring blade extends over almost the entire length of the second groove 55.

As shown in FIG. 3, the first mixer 64 and the second mixer 65 are rotated by the driving source 36 (refer to FIG. 2). The first mixer 64 supplies the developer D in the first groove 54 to the developing roller 61. The second mixer 65 agitates the developer D in the second groove 55. Furthermore, the first mixer 64 conveys the developer D in the first direction X1. The second mixer 65 conveys the developer D in the direction opposite to the first mixer 64. In other words, the second mixer 65 conveys the developer D in the second direction X2. The conveyance directions of the developer D by the first mixer 64 and the second mixer 65 may be opposite to the directions described above.

The partition wall 70 is arranged in the casing 50. The partition wall 70 is vertically formed on a boundary between the first groove 54 and the second groove 55. The partition wall 70 extends along the longitudinal direction and the vertical direction of the casing 50 between the first mixer 64 and the second mixer 65. The partition wall 70 partitions the inside of the casing 50 into the first chamber R1 and the second chamber R2. The first chamber R1 is a space in which the first mixer 64 is disposed. The first chamber R1 communicates with the outside of the casing 50 through the opening 58 of the casing 50. The second chamber R2 is a space in which the second mixer 65 is disposed. The second chamber R2 is a space where the developer D is accommodated at the time of shipment of the image forming apparatus 1.

As shown in FIG. 4, in the partition wall 70, a pair of communicating windows 71 and 72 for enabling the first chamber R1 and the second chamber R2 to communicate with each other is formed. The communicating windows 71 and 72 respectively penetrate the partition wall 70 in the horizontal direction orthogonal to the longitudinal direction of the casing 50. Each of the communicating windows 71 and 72 is formed into a rectangular shape extending in the longitudinal direction and the vertical direction of the casing 50. The first communicating window 71 is formed between the end in the first direction X1 of the stirring blade of the first mixer 64 and the end in the first direction X1 of the stirring blade of the second mixer 65. The first communicating window 71 enables the end in the first direction X1 of the first chamber R1 to communicate with the end in the first direction X1 of the second chamber R2. The second communicating window 72 is formed between an end in the second direction X2 of the stirring blade of the first mixer 64 and an end in the second direction X2 of the stirring blade of the second mixer 65. The second communicating window 72 enables the end in the second direction X2 of the first chamber R1 to communicate with the end in the second direction X2 of the second chamber R2.

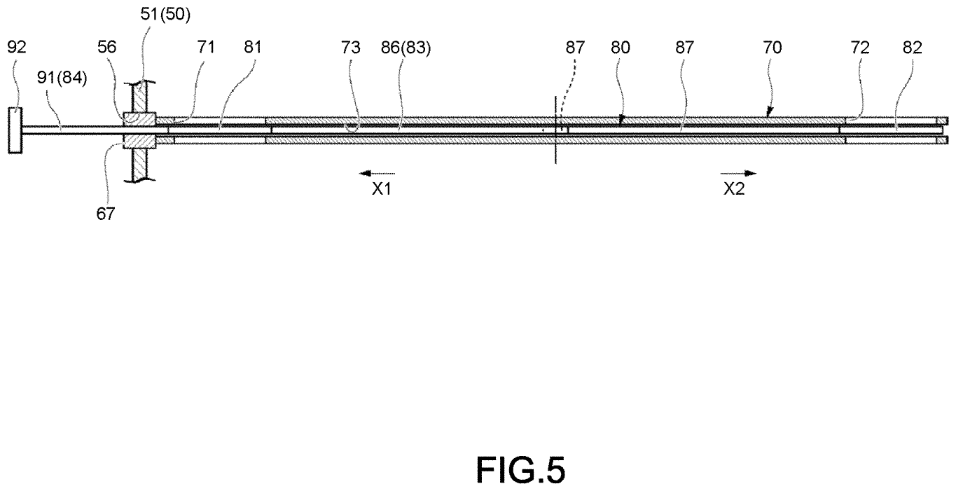

FIG. 5 is a top view schematically illustrating a cross-sectional structure around the partition wall according to the first embodiment.

As shown in FIG. 5, a cavity 73 is formed in the partition wall 70. The cavity 73 is formed in the middle portion in a thickness direction of the partition wall 70. The cavity 73 extends along an extending direction of the partition wall 70. For example, the partition wall 70 is formed by two plates. For example, the cavity 73 is a gap between two plates forming the partition wall 70. The outer peripheral edges of the two plates forming the partition wall 70 may be connected to each other.

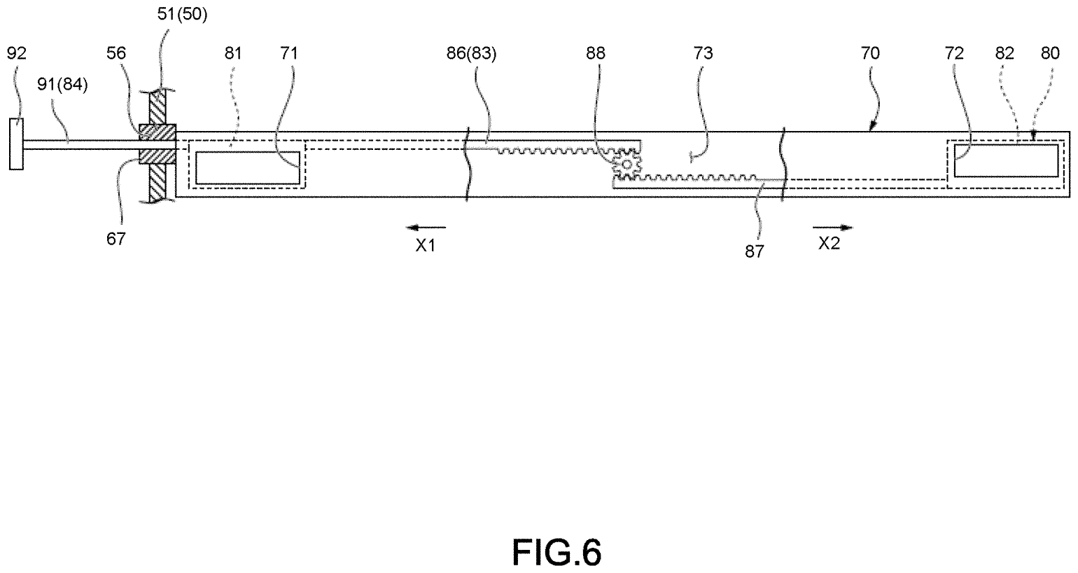

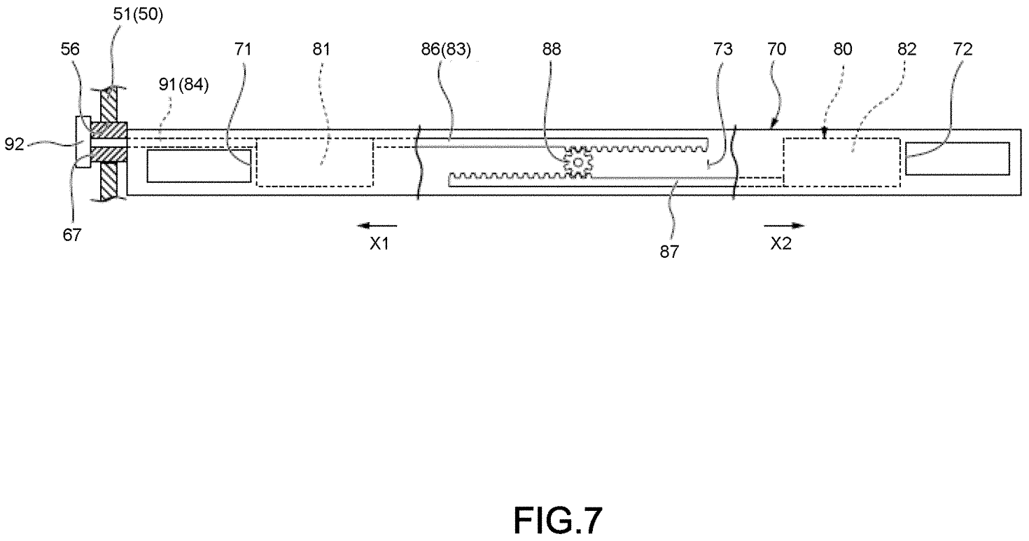

FIG. 6 and FIG. 7 are side views schematically illustrating the structure around the partition wall according to the first embodiment.

As shown in FIG. 6, the shutter device 80 includes a pair of shutters 81 and 82, a linkage mechanism 83, and an operation module 84 (an operation mechanism or operation linkage).

The shutters 81 and 82 are selectively switched between an open state in which the communicating windows 71 and 72 are open and a blocked state in which the communicating windows 71 and 72 are blocked. The open state is as shown in FIG. 7. The blocked state is as shown in FIG. 6. In some embodiments, the blocked state is a state in which the communicating windows 71 and 72 are blocked. By blocking the communicating windows 71 and 72, the shutters 81 and 82 cut off communication between the first chamber R1 and the second chamber R2 (refer to FIG. 3 for both). The shutters 81 and 82 are indirectly connected to each other via the linkage mechanism 83 and can be displaced at the same time. The operation module 84 is operated by a maintenance person when displacing the shutters 81 and 82.

As shown in FIG. 6 and FIG. 7, the shutters 81 and 82 are formed larger than the communicating windows 71 and 72. The shutters 81 and 82 are each formed into a flat plate shape. The shutters 81 and 82 are each formed in a rectangular shape extending in the longitudinal direction and the vertical direction of the casing 50. At least a part of each of the shutters 81 and 82 is arranged in the cavity 73 of the partition wall 70. For example, the shutters 81 and 82 are supported in a slidable manner on the inner surface of the cavity 73 of the partition wall 70. The shutters 81 and 82 can be displaced along the longitudinal direction of the casing 50.

The pair of shutters 81 and 82 includes a first shutter 81 and a second shutter 82. The first shutter 81 blocks the first communicating window 71. The first shutter 81 is displaced from a position where it blocks the first communicating window 71 towards the second communicating window 72 to open the first communicating window 71. When opening the first communicating window 71, the first shutter 81 retreats to the cavity 73 from the inner side of the first communicating window 71. The second shutter 82 blocks the second communicating window 72. The second shutter 82 is displaced from a position where it blocks the second communicating window 72 towards the first communicating window 71 to open the second communicating window 72. When opening the second communicating window 72, the second shutter 82 retreats from the inner side of the second communicating window 72 to the cavity 73.

The linkage mechanism 83 is a rack and pinion mechanism. The linkage mechanism 83 is arranged in the cavity 73 of the partition wall 70. The linkage mechanism 83 includes a first rack 86, a second rack 87, and a pinion 88. The first rack 86 is fixedly supported on the first shutter 81. The first rack 86 extends from the first shutter 81 towards the second shutter 82 along the longitudinal direction of the casing 50. The second rack 87 is fixedly supported on the second shutter 82. The second rack 87 extends from the second shutter 82 towards the first shutter 81 along the longitudinal direction of the casing 50. The pinion 88 is rotatably supported on the partition wall 70. A rotation axis of the pinion 88 is along the horizontal direction orthogonal to the longitudinal direction of the casing 50. The pinion 88 is disposed between the first rack 86 and the second rack 87. The pinion 88 meshes with the first rack 86 and the second rack 87. The pinion 88 displaces the first rack 86 and the second rack 87 in mutually opposite directions. The linkage mechanism 83 simultaneously displaces the first shutter 81 and the second shutter 82.

The operation module 84 is connected to the first shutter 81. The operation module 84 includes an operation rod 91 and a flange 92. The operation rod 91 is provided above the first communicating window 71. The operation rod 91 extends from the first shutter 81 towards a direction opposite to the second shutter 82 along the longitudinal direction of the casing 50. The operation rod 91 extends to the outside of the partition wall 70.

Here, a through hole 56 is formed in the developer housing section 51. The through hole 56 is formed at the first end E1 of the developing device 44. The through hole 56 penetrates the developer housing section 51 in the longitudinal direction of the casing 50. The operation rod 91 is inserted through the through hole 56 of the developer housing section 51 and extends to the outside of the casing 50 at least in the blocked state. A sealing member 67 is interposed between the operation rod 91 and the through hole 56 of the developer housing section 51. The sealing member 67 is formed of, for example, a sponge material. The sealing member 67 is in close contact with the outer peripheral surface of the operation rod 91 and the inner peripheral surface of the through hole 56 of the developer housing section 51. The sealing member 67 fills a gap between the operation rod 91 and the through hole 56 of the developer housing section 51.

The flange 92 is provided at the tip of the operation rod 91. The flange 92 protrudes from the tip of the operation rod 91 in a direction orthogonal to the longitudinal direction of the casing 50. The flange 92 is separated from the casing 50 in the blocked state. The flange 92 blocks the through hole 56 of the developer holding section 51 from the outside in the open state.

A method of using the developing device 44 is described below.

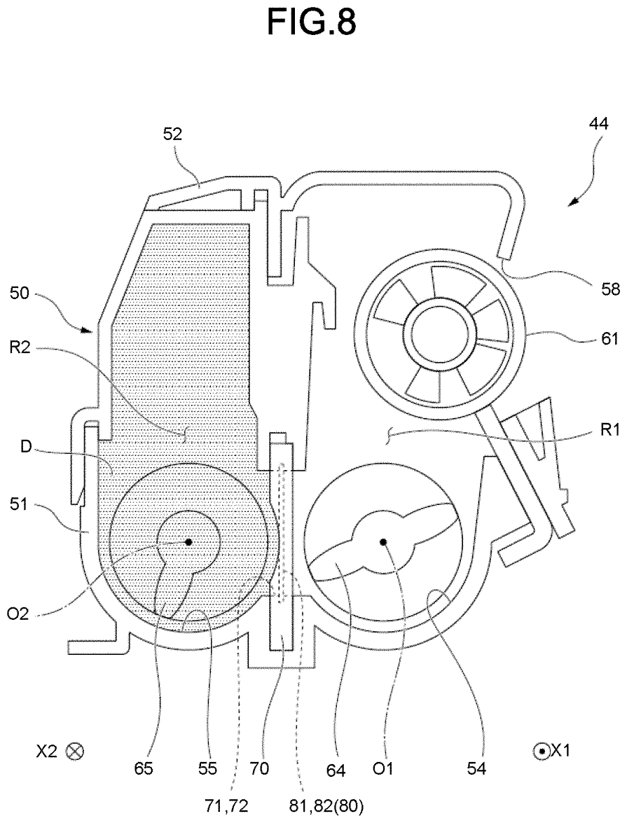

FIG. 8 is a sectional view of the developing device when viewed from the front side according to the first embodiment. FIG. 8 shows the state before the initial setting of the image forming apparatus 1.

As shown in FIG. 6 and FIG. 8, at the time of shipment of the image forming apparatus 1, the communicating windows 71 and 72 of the partition wall 70 are blocked by the shutters 81 and 82. In the second chamber R2 of the developing device 44, the developer D containing the toner at the predetermined concentration is accommodated. The first chamber R1 does not accommodate the developer D. Since the communicating windows 71 and 72 of the partition wall 70 are blocked by the shutters 81 and 82, respectively, the entry of the developer D into the first chamber R1 is restricted. In this way, the developer D is prevented from flowing out of the developing device 44 through the opening 58 of the casing 50.

As shown in FIG. 7, the maintenance person pushes the operation module 84 towards the inside of the casing 50 at the initial setting or the like after the shipment of the image forming apparatus 1. As a result, the first shutter 81 moves from the position where it blocks the first communicating window 71 towards the second communicating window 72 to open the first communicating window 71. When the first shutter 81 moves towards the second communicating window 72, the first rack 86 is displaced towards the second shutter 82, and the pinion 88 rotates. The second rack 87 is displaced toward the first shutter 81. If the second rack 87 moves towards the first shutter 81, the second shutter 82 moves from the position where it blocks the second communicating window 72 towards the first communicating window 71 to open the second communicating window 72. Through the above, the communicating windows 71 and 72 of the partition wall 70 are opened, and the first chamber R1 and the second chamber R2 communicate with each other. The developer D accommodated in the second chamber R2 can enter the first chamber R1. As shown in FIG. 3, if the first mixer 64 and the second mixer 65 are rotated in a state in which the first chamber R1 and the second chamber R2 communicates with each other, the developer D circulates in the first chamber R1 and the second chamber R2. The developer D then is supplied to the developing roller 61 by the first mixer 64.

The effect achieved by some embodiments is described below.

The developing device 44 of some embodiments has the casing 50, the partition wall 70, and a pair of shutters 81 and 82. In the casing 50, the first chamber R1 and the second chamber R2 are formed. In the casing 50, an opening 58 for enabling the first chamber R1 to communicate with the outside is formed. In the partition wall 70, a pair of the communicating windows 71 and 72 for enabling the first chamber R1 to communicate with the second chamber R2 is formed. The shutters 81 and 82 are selectively switched between the open state in which the communicating windows 71 and 72 are opened and the blocked state in which the communicating windows 71 and 72 are blocked.

According to such a configuration, the developer D can be accommodated only in the second chamber R2 and the developer D can be prevented from entering the first chamber R1. Therefore, it is possible to prevent the developer D from leaking out from the first chamber R1 to the outside through the opening 58 of the casing 50 before the initial setting such as at the time shipment of the image forming apparatus 1 having the developing device 44. Moreover, since the communicating windows 71 and 72 are blocked by the shutters 81 and 82, respectively, it is possible to prevent foreign matter from occurring in the casing unlike the prior art. Therefore, it is possible to prevent the developer D from leaking out from the developing device 44 at the time of shipment of the image forming apparatus 1 or the like, while preventing failure in the image formation accompanying the remaining foreign matter from occurring.

The first shutter 81 and the second shutter 82 are connected to each other. As a result, the first shutter 81 and the second shutter 82 can be simultaneously operated to open the communicating windows 71 and 72 collectively. Therefore, it is possible to improve a working efficiency at the time of the initial setting of the image forming apparatus 1.

The first shutter 81 and the second shutter 82 are connected to each other via the linkage mechanism 83 which is a rack and pinion mechanism. The linkage mechanism 83 includes the first rack 86, the second rack 87, and the pinion 88. The first rack 86 is supported on the first shutter 81. The second rack 87 is supported on the second shutter 82. The pinion 88 is disposed between the first rack 86 and the second rack 87 and meshes with the first rack 86 and the second rack 87. According to such a configuration, the first rack 86 and the second rack 87 can be displaced in mutually different directions. Furthermore, the first rack 86 and the second rack 87 can be translated. As a result, the shutters 81 and 82 can also be translated in mutually different directions. Therefore, in the configuration in which the shutters 81 and 82 are moved in mutually different directions, sizes of movement trajectories of shutters 81 and 82 can be minimized. Therefore, it is possible to prevent enlargement of the developing device 44.

The developing device 44 further comprises the first mixer 64 and the second mixer 65. The first mixer 64 is arranged in the first chamber R1 and conveys the developer D in the first direction X1. The second mixer 65 is arranged in the second chamber R2 and conveys the developer D in the second direction X2. The partition wall 70 extends along the longitudinal direction of the casing 50 between the first mixer 64 and the second mixer 65. The pair of the communicating windows 71 and 72 includes the first communicating window 71 and the second communicating window 72. The first communicating window 71 enables the end in the first direction X1 of the first chamber R1 to communicate with the end in the first direction X1 of the second chamber R2. The second communicating window 72 enables the end in the second direction X2 of the first chamber R1 to communicate with the end in the second direction X2 of the second chamber R2. According to such a configuration, the developer D is circulated in the first chamber R1 and the second chamber R2 through the communicating windows 71 and 72 of the partition wall 70 by the first mixer 64 and the second mixer 65. For this reason, the partition wall 70 forms a circulation path for circulating the developer D. Therefore, when compared to a case of separately providing a dividing wall which does not contribute to the formation of the circulation path of the developer D and combining the shutters, an increase in the number of components can be prevented.

The first shutter 81 blocks the first communicating window 71 and is displaced towards the second communicating window 72 to open the first communicating window 71. The second shutter 82 blocks the second communicating window 72 and is displaced towards the first communicating window 71 to open the second communicating window 72. As a result, the shutters 81 and 82 are displaced to approach each other when opening the communicating windows 71 and 72. Therefore, when opening the communicating windows 71 and 72, the shutters 81 and 82 do not protrude from the partition wall 70 in the longitudinal direction of the casing 50. Therefore, it is possible to prevent the enlargement of the developing device 44.

To the second shutter 82, the operation module 84 extending to the outside of the casing 50 is connected. Thus, by operating the operation module 84 outside the casing 50, the shutters 81 and 82 can be operated. Therefore, it is possible to improve working efficiency when opening the communicating windows 71 and 72.

In the casing 50, the through hole 56 through which the operation module 84 is inserted is formed. The operation module 84 includes the flange 92. The flange 92 seals the through hole 56 from the outside with the shutters 81 and 82 opening the communicating windows 71 and 72. As a result, in a state in which the communicating windows 71 and 72 are opened and the developing device 44 becomes usable, the through hole 56 of the casing 50 is sealed by the flange 92. Therefore, leakage of the developer D accommodated in the casing 50 from the through hole 56 can be prevented. Depending on the position of the flange 92, it is easy to recognize whether or not the communicating windows 71 and 72 are opened. Therefore, it is possible to improve a working efficiency when opening the communicating windows 71 and 72.

The sealing member 67 is interposed between the operation module 84 and the through hole 56 to fill the gap between the operation module 84 and the through hole 56. Therefore, the developer D accommodated in the casing 50 can be prevented from leaking out through the gap between the operation module 84 and the through hole 56.

In the partition wall 70, the cavity 73 is formed. In the cavity 73, the shutters 81 and 82 retreat when opening the communicating windows 71 and 72. As a result, the shutters 81 and 82 are disposed inside the partition wall 70 with the communicating windows 71 and 72 opened. Therefore, it is possible to prevent the internal structure of the casing 50 from being complicated.

In some embodiments, the linkage mechanism 83 is the rack and pinion mechanism, but the structure thereof is not limited thereto. The linkage mechanism may be a link mechanism for displacing the shutters 81 and 82 in mutually opposite directions.

### Second Embodiment

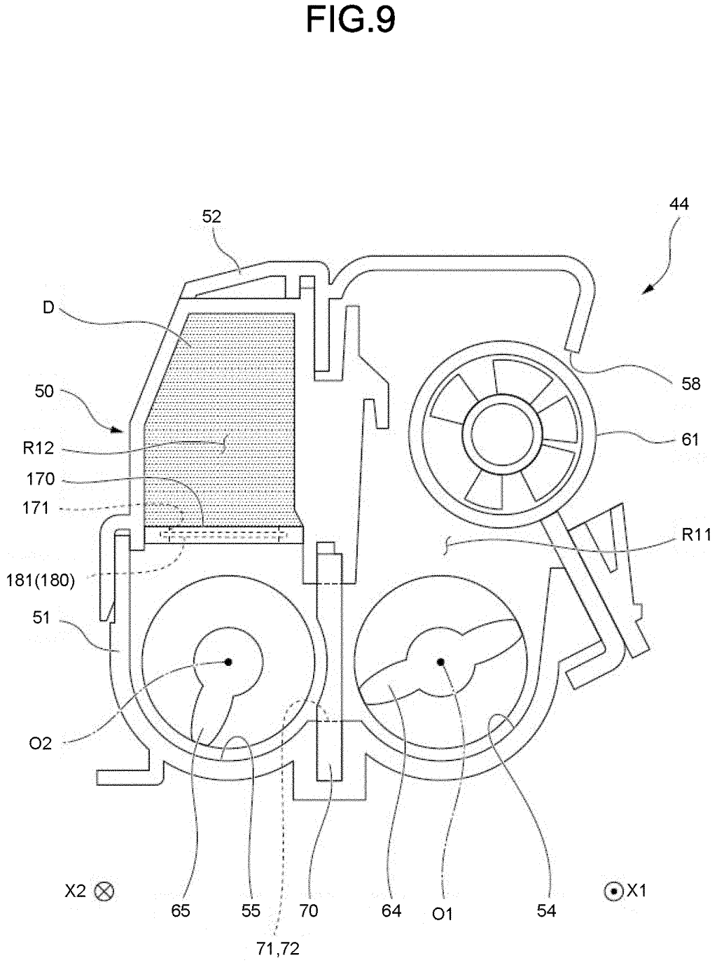

FIG. 9 is a sectional view of the developing device when viewed from the front side according to the second embodiment. FIG. 9 shows the state before the initial setting of the image forming apparatus 1.

The second embodiment shown in FIG. 9 differs from the first embodiment in that a dividing wall 170 is arranged inside the casing 50 separately from the partition wall 70. In the second embodiment, the detailed description of part(s) having the same configuration as in the first embodiment is omitted.

As shown in FIG. 9, the developing device 44 comprises the dividing wall 170. The dividing wall 170 is disposed in the casing 50. The dividing wall 170 is arranged in the second groove 55. The dividing wall 170 extends along the longitudinal direction of the casing 50. The dividing wall 170 divides the inside of the casing 50 into a first chamber R11 and a second chamber R12. The first chamber R11 is a space in which the first mixer 64 and the second mixer 65 are disposed. In the first chamber R11, a space in which the first mixer 64 is arranged and a space in which the second mixer 65 is arranged to communicate with each other through a pair of the communicating windows 71 and 72 of the partition wall 70. The first chamber R11 communicates with the outside of the casing 50 through the opening 58 of the casing 50. The second chamber R12 is a space on the opposite side of the first chamber R11 across the dividing wall 170. The second chamber R12 is a space in which the developer D is accommodated at the time of shipment of the image forming apparatus 1.

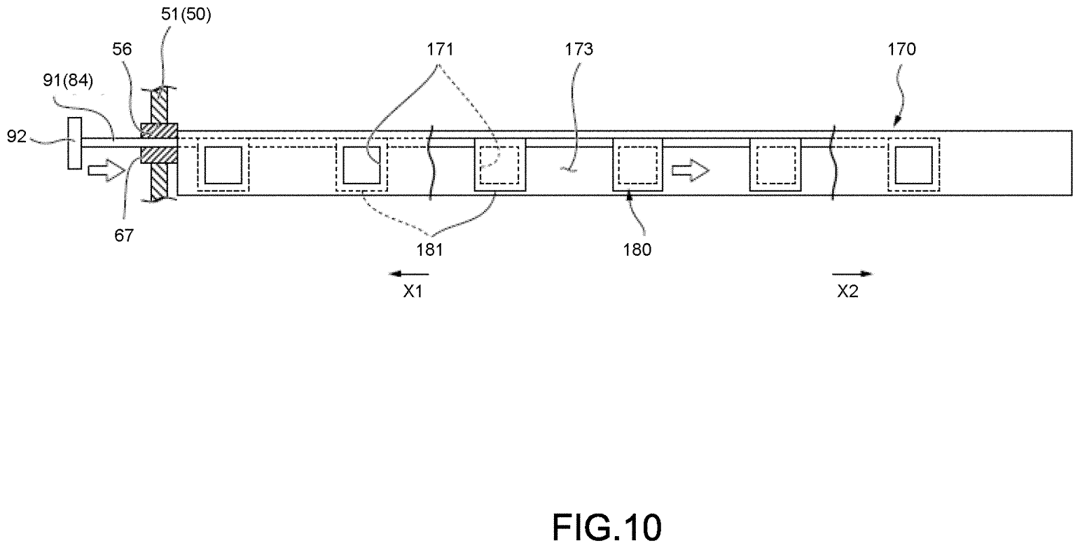

FIG. 10 is a top view schematically illustrating a structure around the dividing wall according to the second embodiment.

As shown in FIG. 10, a plurality of communicating windows 171 for enabling the first chamber R11 to communicate with the second chamber R12 is formed in the dividing wall 170. The plurality of the communicating windows 171 penetrates the dividing wall 170 in the thickness direction of the dividing wall 170, respectively. In the dividing wall 170, a cavity 173 is formed. The cavity 173 is formed at a middle portion in the thickness direction of the dividing wall 170. The cavity 173 extends along an extending direction of the dividing wall 170. For example, the dividing wall 170 is formed of two plates, like the partition wall 70 of the first embodiment. For example, the cavity 173 is a gap between two plates forming the dividing wall 170.

The developing device 44 may include a shutter device 180 instead of the shutter device 80 of the first embodiment. The shutter device 180 includes a plurality of shutters 181 and the operation module 84.

The number of the provided shutters 181 is the same as that of the communicating windows 171. The plurality of shutters 181 is selectively switched between an open state in which a plurality of the communicating windows 171 is opened and a blocked state in which the plurality of the communicating windows 171 is blocked. In some embodiments, the blocked state is a state in which a plurality of the communicating windows 171 is sealed. The plurality of shutters 181 blocks a plurality of the communicating windows 171, thereby blocking the communication between the first chamber R11 and the second chamber R12 (refer to FIG. 9) through the plurality of the communicating windows 171. At least a part of each of the plurality of shutters 181 is arranged in the cavity 173 of the dividing wall 170. For example, the plurality of shutters 181 is supported in a slidable manner on the inner surface of the cavity 173 of the dividing wall 170. The plurality of shutters 181 can be displaced along the longitudinal direction of the casing 50. The plurality of shutters 181 is displaced in the second direction X2, for example, from a position where they block the plurality of the communicating windows 171 to open the plurality of the communicating windows 171. When opening the plurality of the communicating windows 171, the plurality of shutters 181 retreats from the inner side of the plurality of the communicating windows 171 to the cavity 173. The plurality of shutters 181 are directly connected to each other. The plurality of shutters 181 can be displaced simultaneously in the same direction. The operation module 84 is connected to the shutter 181 which is closest to the operation module 84 in the first direction X1 among the plurality of shutters 181.

In some embodiments, as shown in FIG. 9, the partition wall 70 does not need to be provided with the shutter device 80 (refer to FIG. 3). In this case, the cavity 73 (refer to FIG. 5) may not be formed in the partition wall 70. The partition wall 70 functions as a member forming a circulation path of the developer D described above.

Hereinafter, the effect achieved by some embodiments is described.

The developing device 44 of some embodiments has the casing 50, the dividing wall 170, and the plurality of shutters 181. In the casing 50, the first chamber R11 and the second chamber R12 are formed. In the casing 50, the opening 58 for enabling the first chamber R11 to communicate with the outside is formed. In the dividing wall 170, a plurality of the communicating windows 171 for enabling the first chamber R11 to communicate with the second chamber R12 is formed. The plurality of shutters 181 is selectively switched between the open state in which the plurality of the communicating windows 171 is opened and the blocked state in which the plurality of the communicating windows 171 is blocked.

According to such a configuration, the developer D can be accommodated only in the second chamber R12 and the developer D can be prevented from entering the first chamber R11. Therefore, the same effect as that realized by the first embodiment described above can be achieved.

The plurality of shutters 181 is directly connected to each other. As a result, it is possible to operate the plurality of shutters 181 at the same time and open the plurality of the communicating windows 171 collectively. Therefore, it is possible to improve the working efficiency at the time of the initial setting of the image forming apparatus 1.

### Third Embodiment

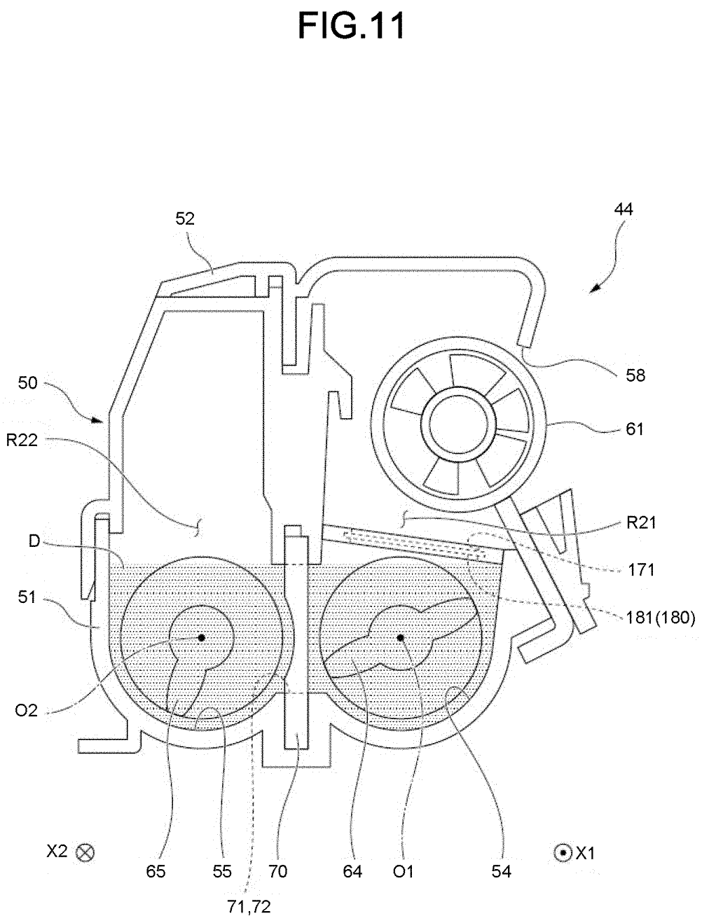

FIG. 11 is a sectional view of the developing device when viewed from the front side according to the third embodiment. FIG. 11 shows a state before the initial setting of the image forming apparatus 1.

In the above-described second embodiment, the dividing wall 170 is disposed above the second mixer 65. In contrast, the third embodiment shown in FIG. 11 is different from the second embodiment in that the dividing wall 170 is arranged above the first mixer 64. In the third embodiment, the detailed description of the parts having the same configuration as in the second embodiment is omitted.

As shown in FIG. 11, a dividing wall 170 is arranged in the first groove 54. The dividing wall 170 divides the inside of the casing 50 into a first chamber R21 and a second chamber R22. The second chamber R22 is a space in which the first mixer 64 and the second mixer 65 are disposed. In the second chamber R22, a space in which the first mixer 64 is disposed and a space in which the second mixer 65 is disposed communicate with each other through a pair of the communicating windows 71 and 72 of the partition wall 70. The second chamber R22 is a space where the developer D is accommodated at the time of shipment of the image forming apparatus 1. The first chamber R21 is a space on the opposite side of the second chamber R22 across the dividing wall 170. The first chamber R21 communicates with the outside of the casing 50 through the opening 58 of the casing 50.

Hereinafter, the effect achieved by some embodiments is described.

The developing device 44 of some embodiments has the casing 50, the dividing wall 170, and a plurality of shutters 181. In the casing 50, the first chamber R21 and the second chamber R22 are formed. The opening 58 is formed in the casing 50 to enable the first chamber R21 to communicate with the outside. In the dividing wall 170, a plurality of the communicating windows 171 for enabling the first chamber R21 to communicate with the second chamber R22 is formed. The plurality of shutters 181 is selectively switched between the open state in which the plurality of the communicating windows 171 is opened and the blocked state in which the plurality of the communicating windows 171 is blocked.

According to such a configuration, the developer D can be accommodated only in the second chamber R22 and the developer D can be prevented from entering the first chamber R21. Therefore, the same effect as that achieved in the first embodiment described above can be achieved.

The shutter which blocks the communicating window of the partition wall (dividing wall) retreats to the cavity of the partition wall (dividing wall) when opening the communicating window, but it is not limited thereto. The shutter may be arranged along an outer surface of the partition wall (the dividing wall) and configured to be displaced along the outer surface of the partition wall (dividing wall).

In the first embodiment, the shutters 81 and 82 are configured to be displaced in mutually opposite directions, but it is not limited thereto. The shutters may be directly connected to each other to be displaced in the same direction.

In each of the above-described embodiments, the plurality of shutters is always linked with each other to be displaced at the same time, but it is not limited thereto. For example, in the first embodiment, when the first rack 86 is displaced by a predetermined distance from the position of the first rack 86 in the blocked state, the first rack 86 may mesh with the pinion 88. As a result, when the first shutter 81 is displaced by the predetermined distance, the second shutter 82 may also be displaced.

In certain embodiments described above, a plurality of the communicating windows is formed in the partition wall (dividing wall), but it is not limited thereto. Only one communicating window may be formed in the partition wall (dividing wall).

According to at least one embodiment described above, the first chamber and the second chamber are formed in the casing. The opening for enabling the first chamber to communicate with the outside is formed in the casing. The shutter is selectively switched between the open state in which the communicating window of the partition wall (dividing wall) is opened and the blocked state in which the communicating window is blocked. According to such a configuration, the developer can be accommodated only in the second chamber, and the developer can be prevented from entering the first chamber. Therefore, the developer can be prevented from leaking out from the first chamber to the outside through the opening of the casing. Therefore, it is possible to prevent the developer from leaking out from the developing device at the time of shipment of the image forming apparatus or the like, while prevent the failure in the image formation accompanying the remaining foreign matter from occurring.

While certain embodiments have been described these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A developing device, comprising:
a developing roller configured to supply developer containing toner to a surface of a photoconductor to develop an electrostatic latent image;
a casing comprising a first chamber, a second chamber, and an opening facing the developing roller, the casing structured such that the opening allows communication between the first chamber and an exterior, the casing being configured to accommodate the developer;
a dividing wall, which is formed in the casing, configured to divide the first chamber and the second chamber, in which at least one communicating window for allowing the first chamber and the second chamber to communicate with each other is formed; and
a shutter configured to be selectively movable between a first state in which the at least one communicating window is opened and a second state in which the at least one communicating window is blocked, so as to be switchable from the first state to the second state and from the second state to the first state.

2. The developing device according to claim 1, wherein
the at least one communicating window includes a first communicating window and a second communicating window,
the shutter includes a first shutter that blocks the first communicating window and a second shutter that blocks the second communicating window, and
the first shutter and the second shutter are connected to each other.

3. The developing device according to claim 2, wherein
the first shutter and the second shutter are connected to each other via a rack and pinion mechanism,
the rack and pinion mechanism includes a first rack supported on the first shutter, a second rack supported on the second shutter, and a pinion disposed between the first rack and the second rack and configured to mesh with the first rack and the second rack.

4. The developing device according to claim 1, further comprising:
a first mixer disposed in the first chamber to convey the developer in a first direction; and
a second mixer disposed in the second chamber to convey the developer in a second direction opposite to the first direction, wherein
the dividing wall extends along the first direction between the first mixer and the second mixer, and
the at least one communicating window includes a first communicating window enabling an end of the first chamber in the first direction and an end of the second chamber in the first direction to communicate with each other, and a second communicating window enabling an end of the first chamber in the second direction and an end of the second chamber in the second direction to communicate with each other.

5. The developing device according to claim 4, wherein
the shutter includes a first shutter configured to block the first communicating window and to be displaced towards the second communicating window to open the first communicating window, and a second shutter configured to block the second communicating window and to be displaced towards the first communicating window to open the second communicating window.

6. The developing device according to claim 1, further comprising
an operation mechanism connected to the shutter and extending to the exterior of the casing.

7. The developing device according to claim 6, wherein
a through hole through which the mechanism is inserted is formed in the casing, and
the operation mechanism includes a flange that seals the through hole from the outside in a state in which the shutter opens the at least one communicating window.

8. The developing device according to claim 6, wherein
a through hole through which the extension is inserted is formed in the casing, and a sealing member filling a gap between the operation mechanism and the through hole is interposed between the operation mechanism and the through hole.

9. The developing device according to claim 1, wherein
in the dividing wall, a cavity is formed into which the shutter retreats when opening the at least one communicating window.

10. An image forming apparatus, comprising:
a photoconductor, and
a developing device comprising
a developing roller configured to supply developer containing toner to a surface of the photoconductor to develop an electrostatic latent image;
a casing comprising a first chamber, a second chamber, and an opening facing the developing roller and permitting the first chamber to communicate with the outside, and configured to accommodate the developer;
a dividing wall formed in the casing and configured to divide the first chamber and the second chamber, in which at least one communicating window permitting the first chamber and the second chamber to communicate with each other is formed; and
a shutter configured to be selectively movable between a first state in which the at least one communicating window is opened and a second state in which the at least one communicating window is blocked, so as to be switchable from the first state to the second state and from the second state to the first state.

11. The image forming apparatus according to claim 10, wherein
the at least one communicating window includes a first communicating window and a second communicating window,
the shutter includes a first shutter that blocks the first communicating window and a second shutter that blocks the second communicating window, and
the first shutter and the second shutter are connected to each other.

12. The image forming apparatus according to claim 11, wherein
the first shutter and the second shutter are connected to each other via a rack and pinion mechanism,
the rack and pinion mechanism includes a first rack supported on the first shutter, a second rack supported on the second shutter, and a pinion disposed between the first rack and the second rack and configured to mesh with the first rack and the second rack.

13. The image forming apparatus according to claim 10, further comprising:
a first mixer disposed in the first chamber to convey the developer in a first direction; and
a second mixer disposed in the second chamber to convey the developer in a second direction opposite to the first direction, wherein
the dividing wall extends along the first direction between the first mixer and the second mixer, and
the at least one communicating window includes a first communicating window enabling an end of the first chamber in the first direction and an end of the second chamber in the first direction to communicate with each other, and a second communicating window enabling an end of the first chamber in the second direction and an end of the second chamber in the second direction to communicate with each other.

14. The image forming apparatus according to claim 13, wherein
the shutter includes a first shutter configured to block the first communicating window and to be displaced towards the second communicating window to open the first communicating window, and a second shutter configured to block the second communicating window and to be displaced towards the first communicating window to open the second communicating window.

15. The image forming apparatus according to claim 10, further comprising
an operation mechanism connected to the shutter and extending to the exterior of the casing.

16. The image forming apparatus according to claim 15, wherein
the casing includes a through hole through which the operation mechanism is insertable.

17. The image forming apparatus according to claim 15, further comprising:
a sealing member disposed in a gap between the operation mechanism and a hole formed in the casing.

18. The image forming apparatus according to claim 10, wherein
in the dividing wall, a cavity is formed into which the shutter retreats when opening the at least one communicating window.

19. The image forming apparatus according to claim 18, wherein the shutter is configured to retreat by a predetermined distance.

20. A method of manufacturing a developing device, comprising:
forming a developing roller configured to supply developer containing a toner to a surface of a photoconductor to develop an electrostatic latent image;
dividing a casing into a first chamber and a second chamber, and forming an opening facing the developing roller, the opening permitting the first chamber to communicate with the outside, the casing being configured to accommodate the developer;
forming a dividing wall in the casing so as to divide the first chamber and the second chamber, the dividing wall including at least one communicating window for permitting the first chamber and the second chamber to communicate with each other; and
providing a shutter configured to be selectively movable between a first state in which the at least one communicating window is opened and a second state in which the at least one communicating window is blocked, so as to be switchable from the first state to the second state and from the second state to the first state.

21. The developing device according to claim 5, further comprising a linkage configured to displace the first shutter and the second shutter simultaneously.
